(19) United States
(12) Patent Application Publication
(10) Pub. No.: US 2026/0363487 A1
(43) Pub. Date: Nov. 19, 2026

(54) DRIVE DEVICE AND FOOD PROCESSOR

(71) Applicant: GUANGDONG MIDEA CONSUMER ELECTRIC MANUFACTURING CO., LTD., Foshan (CN)

(72) Inventors: Jinfeng YANG, Foshan (CN); Binbin WANG, Foshan (CN)

(21) Appl. No.: 19/133,936

(22) PCT Filed: Jun. 29, 2023
(86) PCT No.: PCT/CN2023/104006

§ 371 Date: May 29, 2025

(30) Foreign Application Priority Data
Dec. 1, 2022 (CN) 202211539091.7

(51) Int. Cl. A47J 43/08

(52) U.S. Cl. CPC A47J 43/082

(57) ABSTRACT

A drive device includes a drive shaft, a speed change mechanism, and an output mechanism. The output mechanism includes a first-stage output end connected to the drive shaft and at least one power output end connected to the drive shaft through the speed change mechanism. The first-stage output end and the at least one power output end are concentrically arranged and sequentially sleeved, and speeds output from the first-stage output end and the at least one power output end are different.

### CROSS-REFERENCE TO RELATED APPLICATION

The present application claims priority to Chinese Patent Application No. 202211539091.7, filed on Dec. 1, 2022, entitled “Drive Device and Food Processor,” which is incorporated herein by reference in its entirety.

### FIELD The present application relates to the field of household electrical appliances, and in particular to a drive device and a food processor.

### BACKGROUND

With the improvement of people's living standards and the acceleration of the pace of life, electric kitchen appliances such as a food processor have gradually entered thousands of households.

In the related art, a food processor includes a motor and two output structures, and each output structure is connected to an output shaft of the motor through a transmission mechanism corresponding to each output structure. However, the two output structures are arranged crosswise, resulting in a larger volume of the food processor.

### SUMMARY

The present application is intended to solve at least one of the problems in the related art. The present application provides a drive device and a food processor, which have the characteristic of small volume.

The present application further provides a food processor.

An embodiment of the present application provides a drive device, including:
a drive shaft;
a speed change mechanism; and
an output mechanism, including a first-stage output end and at least one power output end, where the first-stage output end and the at least one power output end are concentrically arranged and sequentially sleeved, the first-stage output end is connected to the drive shaft, and the at least one power output end is connected to the drive shaft through the speed change mechanism; and where speeds output from the first-stage output end and each power output end are different.

According to the drive device of the embodiment of the present application, by concentrically arranging and sequentially sleeving the first-stage output end and the at least one power output end with different speeds, a volume of the speed change mechanism may be decreased, making the structure of the drive device more compact, therapy having the characteristic of small volume.

According to any of above embodiments of the present application, the at least one power output end includes a second-stage output end; where the first-stage output end and the second-stage output end are sequentially sleeved from inside to outside, and a speed of the first-stage output end is greater than a speed of the second-stage output end.

According to any of above embodiments of the present application, the at least one power output end further includes a third-stage output end; where the third-stage output end is sleeved at the second-stage output end, a speed of the third-stage output end being smaller than the speed of the first-stage output end, and the speed of the third-stage output end being greater than the speed of the second-stage output end.

According to any of above embodiments of the present application, the speed change mechanism includes a first transmission assembly and a second transmission assembly; where a transmission ratio of the first transmission assembly is smaller than a transmission ratio of the second transmission assembly;
where the first transmission assembly is power-coupled to the third-stage output end, and the first transmission assembly is connected to the drive shaft; and
where the second transmission assembly is power-coupled to the second-stage output end,
and the second transmission assembly is connected to the drive shaft.

According to any of above embodiments of the present application, the first transmission assembly includes a driving gear and a driven gear, where the driven gear is provided with first outer annular teeth and second outer annular teeth arranged coaxially; where the third-stage output end is provided with a first toothed connection part; and
where the driving gear is sleeved at the drive shaft, the first outer annular teeth are meshed with the driving gear, and the second outer annular teeth are meshed with the first toothed connection part.

According to any of above embodiments of the present application, the first transmission assembly includes a driving gear, a first driven gear, and a second driven gear, where the first driven gear is connected to the second driven gear through a first rotary shaft; where the third-stage output end is provided with a first toothed connection part; and
where the driving gear is sleeved at the drive shaft, the first driven gear is meshed with the driving gear, and the first driven gear is meshed with the first toothed connection part.

According to any of above embodiments of the present application, the second transmission assembly includes a first worm, a second worm, a first worm wheel meshed with the first worm, and a second worm wheel meshed with the second worm; where an exterior of the second-stage output end is provided with a second toothed connection part; and
where the first worm is sleeved at the drive shaft, the second worm is connected to the first worm wheel, and the second worm wheel is meshed with the second toothed connection part.

According to any of above embodiments of the present application, the second transmission assembly includes a first worm, a second worm, a first worm wheel meshed with the first worm, and a second worm wheel meshed with the second worm; where an exterior of the second-stage output end is provided with a second toothed connection part; and where the first worm is connected to the driven gear, the second worm is connected to the first worm wheel, and the second worm wheel is meshed with the second toothed connection part.

According to any of above embodiments of the present application, the second transmission assembly includes a first worm, a second worm, a first worm wheel meshed with the first worm, and a second worm wheel meshed with the second worm; where an exterior of the second-stage output end is provided with a second toothed connection part; and
where the first worm is sleeved at the first rotary shaft, the second worm is connected to the first worm wheel, and the second worm wheel is meshed with the second toothed connection part.

According to any of above embodiments of the present application, the second worm wheel is provided with third outer annular teeth and fourth outer annular teeth arranged coaxially; where the third outer annular teeth are meshed with the second worm, and the fourth outer annular teeth are meshed with the second toothed connection part.

A food processor according to an embodiment of the present application, including:
the drive device as described in any of the above embodiment;
a housing, wrapped around the outside of the drive device; and
a functional device, including a cup body and a working component rotatably arranged inside the cup body, where the cup body is detachably connected to the housing, and the working component is connected to the first-stage output end or any of the power output end.

One or more solutions mentioned above in the embodiments of the present application have at least one of the following effects:
according to the drive device of the embodiment of the present application, by concentrically arranging and sequentially sleeving the first-stage output end and the at least one power output end with different speeds, a volume of the speed change mechanism may be decreased, making the structure of the drive device more compact, thereby having the characteristic of small volume.

Additional aspects and advantages of the present application will be set forth in part in the description which follows and, in part, will be apparent from the description, or may be learned by practice of the present application.

### BRIEF DESCRIPTION OF DRAWINGS

In order to more clearly illustrate the solutions according to the present application or the related art, the accompanying drawings used in the description of the embodiments of the present application or the related art will be briefly introduced below. It should be noted that the drawings in the following description are only part embodiments of the present application. For those of ordinary skill in the art, other drawings can also be obtained according to these drawings without any creative effort.

FIG. 1 is a first schematic three-dimensional structural diagram of a drive device according to an embodiment of the present application;

FIG. 2 is a second schematic three-dimensional structural diagram of a drive device according to an embodiment of the present application;

FIG. 3 is a first schematic exploded diagram of a drive device according to an embodiment of the present application;

FIG. 4 is an assembly schematic diagram of a speed change mechanism and an output mechanism;

FIG. 5 is a schematic structural diagram of a driven gear set according to an embodiment of the present application;

FIG. 6 is a top view of a drive device according to an embodiment of the present application;

FIG. 7 is a schematic cross-sectional structural side view along a section line A-A in FIG. 6;

FIG. 8 is a schematic cross-sectional structural side view along a section line B-B in FIG. 6;

FIG. 9 is a first schematic structural diagram of a drive device according to an embodiment of the present application;

FIG. 10 is a second schematic structural diagram of a drive device according to an embodiment of the present application;

FIG. 11 is a schematic cross-sectional structural side view along a section line C-C in FIG. 10;

FIG. 12 is a schematic cross-sectional structural side view along a section line D-D in FIG. 10;

FIG. 13 is a third schematic structural diagram of a drive device according to an embodiment of the present application;

FIG. 14 is a schematic diagram showing motion transmission of a drive device according to an embodiment of the present application; and

FIG. 15 is a second schematic exploded diagram of a drive device according to an embodiment of the present application.

### REFERENCE NUMERALS

1: drive mechanism; 11: drive member; 12: drive shaft;

2: speed change mechanism;

21: first transmission assembly; 211: driving gear; 212: driven gear; 2121: first outer annular teeth; 2122: second outer annular teeth; 213: first driven gear; 214: second driven gear; 215: first rotary shaft;

22: second transmission assembly; 221: first worm; 222: first worm wheel; 223: second worm; 224: second worm wheel; 2241: third outer annular teeth; 2242: fourth outer annular teeth; 225: worm shaft; 226: second rotary shaft;

3: output mechanism; 31: first-stage output end; 32: second-stage output end; 321: second toothed connection part; 33: third-stage output end; 331: first toothed connection part; 34: bearing;

4: gearbox; 41: upper gearbox housing; 42: lower gearbox housing; 421: first bearing seat; 422: second bearing seat; 423: third bearing seat.

### DETAILED DESCRIPTION OF THE EMBODIMENTS

Embodiments of the present application are further described in detail below with reference to the drawings and embodiments. The following embodiments are intended to illustrate the present application, but are not intended to limit the scope of the present application.

Serial numbers of the members in the embodiments of the present application, such as “first,” “second”; (1), (2), (3); step 1, and step 2 are only used to distinguish the objects described and do not have any order or technical meaning. Unless otherwise specified, the meaning of “multiple” refers to two or more. Terms “include,” “comprise,” “provided with,” “contain,” and the like used in the embodiments of the present application are all open terms, which means including but not limited to. The term “and/or” in the embodiments of the present application only describes a related relationship of associated objects, and indicates that there may be three kinds of relationships. For example, A and/or B can represent that A exists alone, A and B exist simultaneously, and B exists alone.

In the embodiments of the present application, words “as an example” or “for example” are used to indicate examples, illustrations or descriptions. Any embodiment or design schemes described as “as an example” or “for example” in the embodiments of the present application should not be interpreted as being more preferred or more advantageous than other embodiments or design schemes. In some embodiments, the use of words such as “as an example” or “for example” is intended to present related concepts in a specific way. Unless otherwise defined, all technical and scientific terms used in the embodiments of the present application have the same meaning as those generally understood by those skilled in the art of the present application. In the event of any inconsistency, the meaning described in this specification or the meaning derived from the content recorded in the specification shall prevail.

In the description of the embodiments of the present application, it should be noted that the orientation or positional relationships indicated by the terms such as “center,” “longitudinal,” “lateral,” “upper,” “lower,” “front,” “back,” “left,” “right,” “vertical,” “horizontal,” “top,” “bottom,” “inside,” and “outside,” are based on the orientation or positional relationship shown in the drawings, and are merely for the convenience of describing the embodiments of the present application and simplifying the description, rather than indicating or implying that the device or component stated must have a particular orientation, or be constructed and operated in a particular orientation, and thus cannot be understood as limitation to the embodiments of the present application. Furthermore, the terms “first,” “second,” “third” are only used for descriptive purposes and should not be construed as indicating or implying a relative importance.

In the description of embodiments of the present application, it should be noted that, unless otherwise explicitly specified and defined, the terms “connected to” and “connected” shall be understood broadly, for example, it may refer to a fixed connection, a detachable connection, or an integrated connection; it may refer to a mechanical connection or an electric connection; or it may refer to a direct connection or an indirect connection via an intermediate medium. The specific meanings of the terms above in embodiments of the present application may be understood by those skilled in the art in accordance with specific circumstances.

In the embodiments of the present application, unless otherwise clearly stated and defined, the first feature being located “on” or “under” the second feature may mean that the first feature is in direct contact with the second feature or the first feature is in indirect contact with the second feature by an intermediate medium. In addition, the first feature being “on,” “above” and “over” the second feature may refer to that the first feature is directly above or obliquely above the second feature, or simply refer to that the level of the first feature is higher than that of the second feature. The first feature being “under,” “below” and “beneath” the second feature may refer to that the first feature is directly below or obliquely below the second feature, or simply refer to that the level of the first feature is lower than that of the second feature.

In the description of the present specification, the description with reference to the terms “one embodiment,” “some embodiments,” “an example,” “specific example,” “some examples” and the like, refers to that specific features, structures, materials or characteristics described in combination with an embodiment or an example are included in at least one embodiment or example of the embodiments of the present application. In the present specification, the schematic expressions of the above terms are not necessarily directed to the same embodiment or example. Furthermore, the particular features, structures, materials or characteristics described may be combined in any suitable manner in any one or more embodiments or examples. In addition, those skilled in the art may combine different embodiments or examples described in this specification, as well as the features of different embodiments or examples, without conflicting each other.

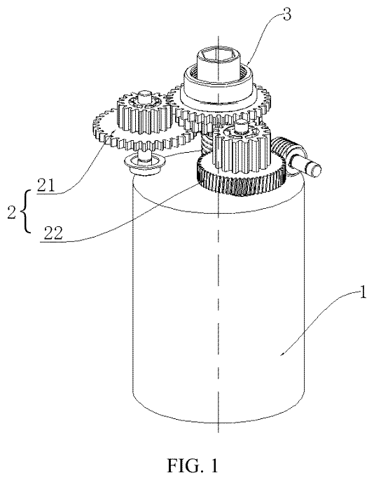

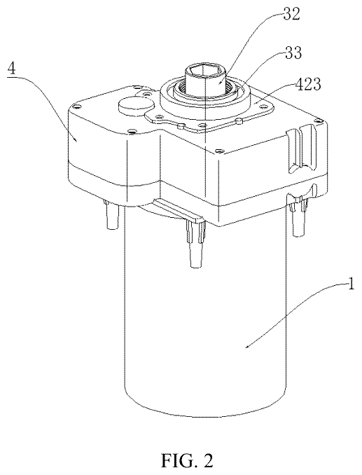

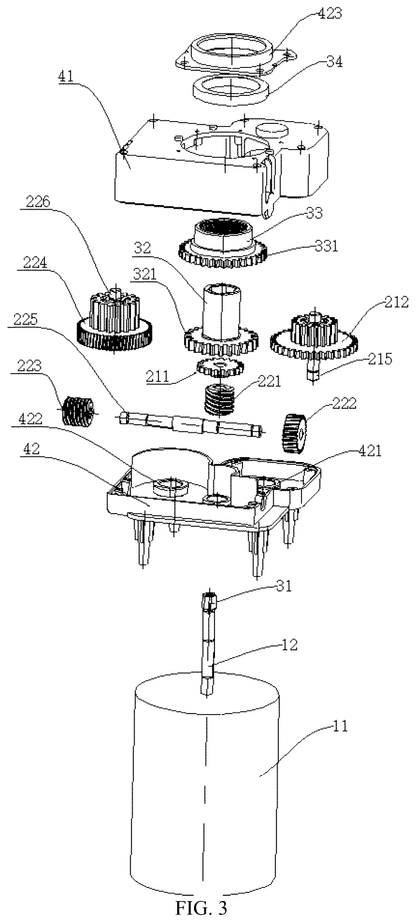

An embodiment of the present application provides a drive device. FIG. 1 is a first schematic three-dimensional structural diagram of a drive device according to an embodiment of the present application; FIG. 2 is a second schematic three-dimensional structural diagram of a drive device according to an embodiment of the present application; and FIG. 3 is a first schematic exploded diagram of a drive device according to an embodiment of the present application. As shown in FIG. 1 and FIG. 3, the drive device includes a drive shaft 12, a speed change mechanism 2, and an output mechanism 3. The output mechanism 3 includes a first-stage output end 31 and at least one power output end, where the first-stage output end 31 and the at least one power output end are concentrically arranged and sequentially sleeved, the first-stage output end 31 is connected to the drive shaft 12, and the at least one power output end is connected to the drive shaft 12 through the speed change mechanism 2; and where speeds output from the first-stage output end 31 and each power output end are different.

It is understandable that the output mechanism 3 includes at least two output ends. FIG. 1 to FIG. 3 show three output ends, one of which is directly connected to the drive shaft 12 and the drive shaft 12 directly drives the output end to rotate. An output end connected to the drive shaft 12 serves as the first-stage output end 31; the remaining output ends serve as power output ends. The number of power output ends may be one or more, and they are concentrically sleeved at the first-stage output end 31 in sequence. In order to realize the movement of the power output ends, each power output end is connected to the drive shaft 12 through the speed change mechanism 2.

It is understandable that the first-stage output end 31 of the output mechanism 3 is driven through the drive shaft 12, and the power output end is driven through the speed change mechanism 2 connected to the drive shaft 12. When there is a plurality of power output ends, in order to obtain different speeds of each power output end, the speed change mechanism 2 needs to include a plurality of transmission assemblies, and the plurality of transmission assemblies respectively drive the plurality of power output ends to rotate, and transmission ratios of the plurality of transmission assemblies are different. The output speed of the drive member 11 is transmitted to different power output ends through different transmission assemblies, so that the rotation speeds of the plurality of power output ends are different, thereby the rotation speeds of the first-stage output end 31 and each power output end are different.

It is understandable that speeds of all output ends of the output mechanism 3 (the first-stage output end 31 and each power output end) are different. A plurality of functional devices with different functions may be designed based on the number of output ends of the output mechanism 3. By assembling functional devices with different functions at the corresponding output ends, different food processing functions may be realized. For example, when a speed of the output end is high, the functional device may be a wall-breaking machine with a crushing knife for wall-breaking cooking. When a speed of the output end is low, the functional device may be a juicer with a screw for squeezing juice or a stir-frying machine with a stirring spatula. When a speed of the output end is in the middle, the functional device may be a meat grinder, a shredder, a slicer, and the like with a cutter having a food processing function.

It should be noted that the functional device includes a cup body and a working component rotatably arranged inside the cup body. Different functions of the functional device may refer to different working components, specifically different working members of the working components, and the working member may be a working knife.

According to the drive device of the embodiment of the present application, by concentrically arranging and sequentially sleeving the first-stage output end 31 and the at least one power output end with different speeds, a volume of the speed change mechanism 2 may be decreased, making the structure of the drive device more compact structure, thereby having the characteristic of small volume.

In an embodiment of the present application, the at least one power output end includes a second-stage output end 32; where the first-stage output end 31 and the second-stage output end 32 are sequentially sleeved from inside to outside, and a speed of the first-stage output end 31 is greater than a speed of the second-stage output end 32.

It is understandable that there are two output ends of the output mechanism 3, namely the first-stage output end 31 and the second-stage output end 32. The second-stage output end 32 is sleeved at the first-stage output end 31, and the second-stage output end 32 is connected to the drive shaft 12 through the speed change mechanism 2. The drive shaft 12 then drives the first-stage output end 31 to rotate, and at the same time, the drive shaft 12 drives the second-stage output end 32 to rotate through the speed change mechanism 2. The speed of the second-stage output end 32 may be smaller than the speed of the first-stage output end 31 through the deceleration effect of the speed change mechanism 2.

In an embodiment of the present application, the at least one power output end further includes a third-stage output end 33; where the third-stage output end 33 is sleeved at the second-stage output end 32, a speed of the third-stage output end 33 is smaller than the speed of the first-stage output end 31, and the speed of the third-stage output end 33 is greater than the speed of the second-stage output end 32.

It is understandable that there are three output ends of the output mechanism 3, namely the first-stage output end 31, the second-stage output end 32 and the third-stage output end 33 sequentially sleeved from inside to outside. The second-stage output end 32 and the third-stage output end 33 are respectively connected to the drive shaft 12 through the speed change mechanism 2. Then the drive shaft 12 drives the first-stage output end 31 to rotate, and at the same time, the drive shaft 12 drives the second-stage output end 32 and the third-stage output end 33 to rotate through the speed change mechanism 2. The speeds of the second-stage output end 32 and the third-stage output end 33 may be smaller than the speed of the first-stage output end 31, and the speed of the third-stage output end 33 may be greater than the speed of the second-stage output end 32 through the deceleration effect of the speed change mechanism 2.

It is understandable that an output speed of the first-stage output end 31 of the output mechanism 3 is the largest, an output speed of the second-stage output end 32 is the smallest, and an output speed of the third-stage output end 33 is between the largest speed and the smallest speed. Output speeds of the three output ends of the output mechanism 3 from inside to outside are respectively the largest, the smallest, and the middle (between the largest and the smallest).

It should be noted that the output speed of the output mechanism 3 is the highest in the innermost circle (first-stage output end 31), the output speed of the output mechanism 3 is the second highest in the outermost circle (third-stage output end 33), and the output speed of the output mechanism 3 is the lowest in the middle circle (second-stage output end 32). The reason for this layout is that the slowest speed has the largest output torque. If the second-stage output end 32 with the slowest rotation speed is placed in the outermost circle, a force arm of the second-stage output end 32 will become larger, and the requirement for strength of the second-stage output end 32 will be higher, making the overall structure of the drive device bulky. If the second-stage output end 32 with the slowest speed is placed in the innermost circle, which is theoretically the best, but this will make the first-stage output end 31 with the highest speed unable to be transmitted across stages. Therefore, only when the second-stage output end 32 with the slowest speed is placed between the first-stage output end 31 with the highest speed and the third-stage output end 33 with the second highest speed, the layout is the most suitable, and it also makes the structure more compact and the transmission smoother.

According to the drive device of the embodiment of the present application, by placing the second-stage output end 32 with the slowest speed between the first-stage output end 31 with the highest speed and the third-stage output end 33 with the second highest speed, the structure is more compact and the force transmission is smoother.

According to the embodiment of the invention, as shown in FIG. 1 and FIG. 3, there are three output ends of the output mechanism 3, one of which is connected to the drive shaft 12. The speed change mechanism 2 includes two transmission assemblies, namely the first transmission assembly 21 and the second transmission assembly 22. The first transmission assembly 21 is power-coupled to the third-stage output end 33, and the first transmission assembly 21 is connected to the drive shaft 12; and the second transmission assembly 22 is power-coupled to the second-stage output end 32, and the second transmission assembly 22 is connected to the drive shaft 12.

It is understandable that the drive shaft 12 drives the first-stage output end 31 to rotate, and at the same time, the drive shaft 12 drives the third-stage output end 33 to rotate through the first transmission assembly 21, and the drive shaft 12 drives the second-stage output end 32 to rotate through the second transmission assembly 22. In order to achieve that the speed of the third-stage output end 33 is greater than the speed of the second-stage output end 32, a transmission ratio of the first transmission assembly 21 is smaller than a transmission ratio of the second transmission assembly 22.

It is understandable that both the speed of the third-stage output end 33 and the speed of the second-stage output end 32 are smaller than the speed of the first-stage output end 31, then both the first transmission assembly 21 and the second transmission assembly 22 should be deceleration transmission assemblies, that is, both the transmission ratios of the first transmission assembly 21 and the second transmission assembly 22 are greater than 1.

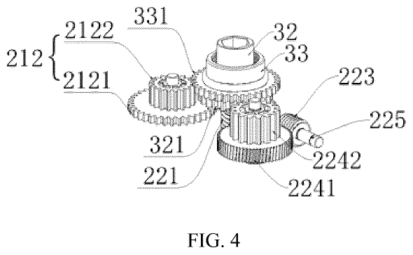

In an embodiment of the present application, FIG. 4 is an assembly schematic diagram of a speed change mechanism and an output mechanism. As shown in FIG. 3 and FIG. 4, the first transmission assembly 21 includes a driving gear 211 and a driven gear 212. The driven gear 212 is provided with first outer annular teeth 2121 and second outer annular teeth 2122 arranged coaxially. The third-stage output end 33 is provided with a first toothed connection part 331; the driving gear 211 is sleeved at the drive shaft 12, the first outer annular teeth 2121 are meshed with the driving gear 211, and the second outer annular teeth 2122 are meshed with the first toothed connection part 331.

It is understandable that the driving gear 211 is fixedly sleeved at the drive shaft 12, and the driving gear 211 is driven to rotate synchronously during the rotation of the drive shaft 12. The driving gear 211 is meshed with the first outer annular teeth 2121 of the driven gear 212, then the driving gear 211 drives the driven gear 212 to rotate. The second outer annular teeth 2122 of the driven gear 212 are meshed with the first toothed connection part 331 of the third-stage output end 33, then the driven gear 212 drives the third-stage output end 33 to rotate. As such, the drive shaft 12 transmits power to the third-stage output end 33 through the driving gear 211 and the driven gear 212 in sequence, and the drive shaft 12 then drives the third-stage output end 33 to rotate through the first transmission assembly 21.

It is understandable that the driving gear 211 may be splined to the drive shaft 12, and a retaining ring for axially limiting the driving gear 211 is provided on the drive shaft 12.

It is understandable that the driven gear 212 may be a double gear structure. The driven gear 212 includes a first shaft part and a second shaft part that are fixedly connected, the first shaft part is provided with first outer annular teeth 2121, and the second shaft part is provided with second outer annular teeth 2122. A diameter of the first shaft part is greater than a diameter of the driving gear 211, and a diameter of the second shaft part is smaller than the diameter of the first shaft part. A diameter of the first toothed connection part 331 of the third-stage output end 33 is greater than the diameter of the second shaft part, and the first transmission assembly 21 may be realized as a deceleration transmission assembly.

In an embodiment of the present application, as shown in FIG. 3 and FIG. 4, the second transmission assembly 22 includes a first worm 221, a first worm wheel 222, a second worm 223 and a second worm wheel 224. An exterior of the second-stage output end 32 is provided with a second toothed connection part 321, the first worm 221 is sleeved at the drive shaft 12, and the first worm wheel 222 is meshed with the first worm 221. The second worm 223 is connected to the first worm wheel 222, the second worm wheel 224 is meshed with the second worm 223, and the second worm wheel 224 is meshed with the second toothed connection part 321.

It is understandable that the first worm 221 is sleeved at the drive shaft 12, then the first worm 221 is driven to rotate during the rotation of the drive shaft 12. The first worm wheel 222 is meshed with the first worm 221, then the first worm 221 drives the first worm wheel 222 to rotate. The second worm 223 is connected to the first worm wheel 222, and the second worm 223 rotates synchronously with the first worm wheel 222. The second worm wheel 224 is meshed with the second worm 223, then the second worm 223 drives the second worm wheel 224 to rotate. The second worm wheel 224 is meshed with the second toothed connection part 321 of the second-stage output end 32, then the second worm wheel 224 drives the second-stage output end 32 to rotate. As such, the drive shaft 12 transmits power to the second-stage output end 32 through the first worm 221, the first worm wheel 222, the second worm 223, and the second worm wheel 224 in sequence, and then the drive shaft 12 drives the second-stage output end 32 to rotate through the second transmission assembly 22.

It is understandable that the first worm 221 may be splined to the drive shaft 12, and a retaining ring for axially limiting the first worm 221 is provided on the drive shaft 12.

It is understood that the second worm 223 may be coaxially connected to the first worm wheel 222 through a worm shaft 225.

According to an embodiment of the present application, the second worm wheel 224 is provided with third outer annular teeth 2241 and fourth outer annular teeth 2242 arranged coaxially; where the third outer annular teeth 2241 are meshed with the second worm 223, and the fourth outer annular teeth 2242 are meshed with the second toothed connection part 321.

It is understandable that, as shown in FIG. 4, the second worm wheel 224 may be a double gear structure. The second worm wheel 224 includes a third shaft part and a fourth shaft part that are fixedly connected. The third shaft part is provided with third outer annular teeth 2241, and the fourth shaft part is provided with fourth outer annular teeth 2242. By allowing a diameter of the third shaft part to be greater than a diameter of the fourth shaft part, the second transmission assembly 22 may be realized as a deceleration transmission assembly, and in combined with the structure of worm gear (first worm 221, first worm wheel 222), a transmission ratio of the second transmission assembly 22 may be greater than a transmission ratio of the first transmission assembly 21, thereby obtaining an output speed of the second-stage output end 32 driven through the second transmission assembly 22 lower than an output speed of the third-stage output end 33 driven through the first transmission assembly 21.

According to an embodiment of the present application, the second worm wheel 224 may also be provided with two transmission gears that are coaxially arranged and connected by a rotary shaft, one of two transmission gears is meshed with the second worm 223, and the other transmission gear is meshed with the second toothed connection part 321 of the second-stage output end 32.

In another embodiment of the present application, a mounting position of the first worm 221 of the second transmission assembly 22 is adjusted, and the first worm 221 is adjusted from being fixedly sleeved at the drive shaft 12 to being connected to the driven gear 212.

It is understood that the first worm 221 may be coaxially connected to the driven gear 212 through a rotary shaft.

It is understandable that the drive shaft 12 drives the first-stage output end 31 to rotate, and at the same time, the drive shaft 12 drives the third-stage output end 33 to rotate through the driving gear 211 and the driven gear 212, and the driven gear 212 drives the second-stage output end 32 to rotate through the first worm 221, the first worm wheel 222, the second worm 223, and the second worm wheel 224.

According to the drive device of the embodiment of the present application, the first worm 221 of the second transmission assembly 22 is connected to the driven gear 212, which may reduce the transmission ratio of the second transmission assembly 22 while remaining the speed of the second-stage output end 32 unchanged, thereby further decreasing the volume of the drive device.

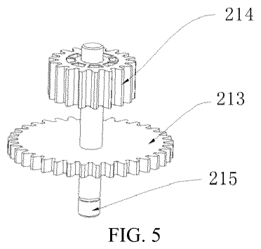

In another embodiment of the present application, FIG. 5 is a schematic structural diagram of a driven gear set according to an embodiment of the present application. The first transmission assembly 21 includes a driving gear 211 and a driven gear set. The driven gear set includes a first driven gear 213 and a second driven gear 214. The first driven gear 213 is coaxially connected to the second driven gear 214 through a first rotary shaft 215. The third-stage output end 33 is provided with a first toothed connection part 331. The driving gear 211 is sleeved at the drive shaft 12. The first driven gear 213 is meshed with the driving gear 211, and the second driven gear 214 is meshed with the first toothed connection part 331.

It is understandable that the driving gear 211 is fixedly sleeved at the drive shaft 12, then the driving gear 211 is driven to rotate synchronously during the rotation of the drive shaft 12. The driving gear 211 is meshed with the first driven gear 213, then the driving gear 211 drives the first driven gear 213 to rotate. The first driven gear 213 is coaxially connected to the second driven gear 214, then the second driven gear 214 rotates synchronously with the first driven gear 213. The second driven gear 214 is meshed with the first toothed connection part 331 of the third-stage output end 33, then the second driven gear 214 drives the third-stage output end 33 to rotate, as such the drive shaft 12 transmits power to the third-stage output end 33 through the driving gear 211, the first driven gear 213 and the second driven gear 214 in sequence.

In another embodiment of the present application, in case that the first transmission assembly 21 includes a driving gear 211 and a driven gear set, and the driven gear set includes a first driven gear 213 and a second driven gear 214 that are coaxially connected through a first rotary shaft 215, the first worm 221 of the second transmission assembly 22 may fixedly sleeved at the first rotary shaft 215, the first worm wheel 222 is meshed with the first worm 221, the second worm 223 is connected to the first worm wheel 222, the second worm wheel 224 is meshed with the second worm 223, and the second worm wheel 224 is meshed with the second toothed connection part 321.

It is understandable that the drive shaft 12 drives the first-stage output end 31 to rotate, and at the same time, the drive shaft 12 drives the third-stage output end 33 to rotate through the driving gear 211, the first driven gear 213 and the second driven gear 214 in sequence, and the first rotary shaft 215 fixedly connected to the first driven gear 213 and the second driven gear 214 drives the second-stage output end 32 to rotate through the first worm 221, the first worm wheel 222, the second worm 223, and the second worm wheel 224.

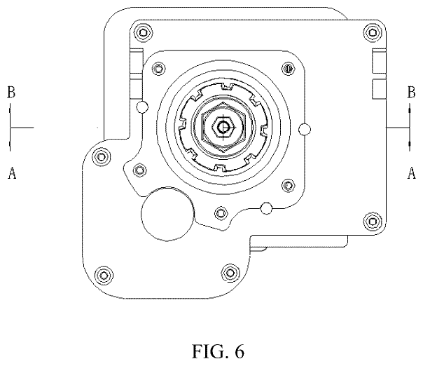

In an embodiment of the present application, FIG. 6 is a top view of a drive device according to an embodiment of the present application. As shown in FIG. 2, FIG. 3 and FIG. 6, the drive device further includes a gearbox 4, and the gearbox 4 wraps around the outside of the speed change mechanism 2.

It is understandable that the drive mechanism 1 further includes a drive member 11, and the drive shaft 12 is connected to an output of the drive member 11, and the drive shaft 12 is driven to rotate by the drive member 11. The speed change mechanism 2 is connected to the drive shaft 12, and the gearbox 4 is located above the drive member 11. The gearbox 4 may include a lower gearbox housing 42 and a upper gearbox housing 41. The lower gearbox housing 42 is mounted on the drive member 11. In order to facilitate the maintenance of the speed change mechanism 2, the upper gearbox housing 41 is assembled on the lower gearbox housing 42 in a detachable connection.

It is understandable that the lower gearbox housing 42 is provided with a mounting hole through which the drive shaft 12 passes. The driven gear 212 is rotatably arranged at the lower gearbox housing 42 through the first rotary shaft 215, and the lower gearbox housing 42 is provided with a first bearing seat 421 matched with the first rotary shaft 215. The second worm wheel 224 is rotatably arranged at the lower gearbox housing 42 through the second rotary shaft 226, and the lower gearbox housing 42 is provided with a second bearing seat 422 matched with the second rotary shaft 226; the worm shaft 225 is rotatably arranged at the lower gearbox housing 42 or the upper gearbox housing 41 through a bearing.

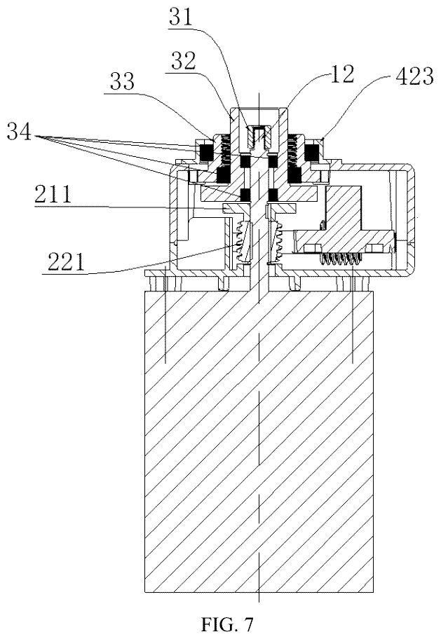

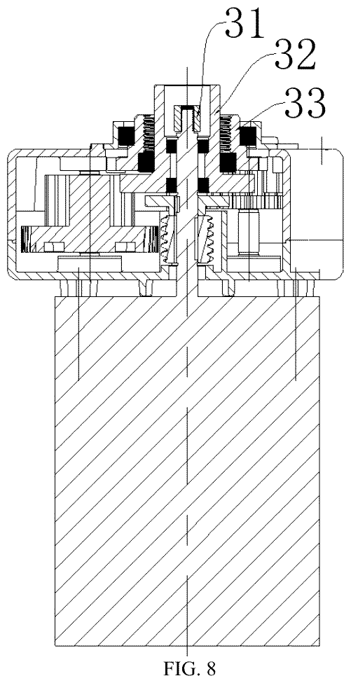

In another embodiment of the present application, FIG. 7 is a schematic cross-sectional structural side view along a section line A-A in FIG. 6; FIG. 8 is a schematic cross-sectional structural side view along a section line B-B in FIG. 6. As shown in FIG. 7 and FIG. 8, the first-stage output end 31 includes a first output shaft being a hollow structure. A lower part of the first output shaft is fixedly sleeved at the upper end of the drive shaft 12, and an upper inner wall of the first output shaft is used to be connected with the working component of the functional device. The first output shaft may be in a threaded connection with the drive shaft 12, and the thread has a locking function.

The second-stage output end 32 includes a second output shaft being a hollow structure, and a second toothed connection part 321 arranged at an outer wall of the second output shaft. The second output shaft is sleeved at an outer periphery of the first output shaft and the drive shaft 12, and the second output shaft may rotate relative to the drive shaft 12. A lower inner surface of the second output shaft in the embodiment of the present application may be sleeved at the drive shaft 12 through a bearing 34, and the first output shaft is located in the cavity at the upper part of the second output shaft. In an embodiment, the second output shaft is arranged at the drive shaft 12 through two bearings 34. An inner surface of the second output shaft is provided with an annular limiting protrusion located between the two bearings 34. The adjacent end surfaces of the two bearings 34 are axially limited by the annular limiting protrusion. The inner surface of the second output shaft may also be provided with two limit parts extending into limiting grooves on the drive shaft 12, and the other end surfaces of the two bearings 34 are axially limited by the two limit parts.

The third-stage output end 33 includes a third output shaft being a hollow structure, and a first toothed connection part 331 arranged at an outer wall of the third output shaft. The third output shaft is sleeved at an outer periphery of the second output shaft and may rotate relative to the second output shaft. In the embodiment of the present application, the third output shaft is sleeved at the second output shaft through a bearing 34, and the third output shaft is rotatably connected to the upper gearbox housing 41. Then, the upper gearbox housing 41 may be provided with a third bearing seat 423, and a bearing 34 is arranged between the third bearing seat 423 and the third output shaft.

It is understandable that the third bearing seat 423 may be a large bearing seat, and the first bearing seat 421 and the second bearing seat 422 are small bearing seats.

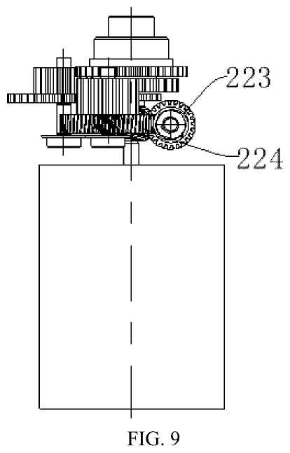

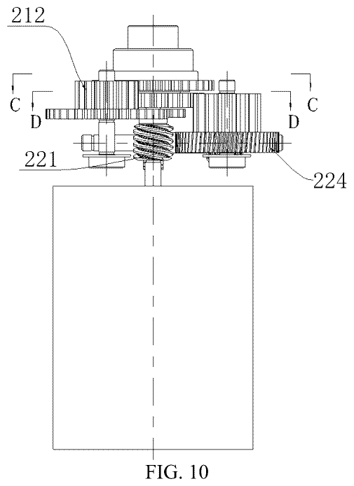

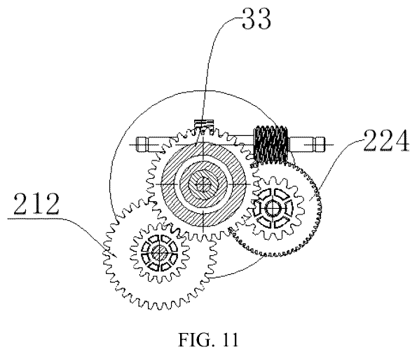

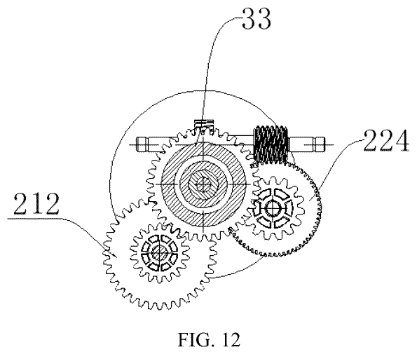

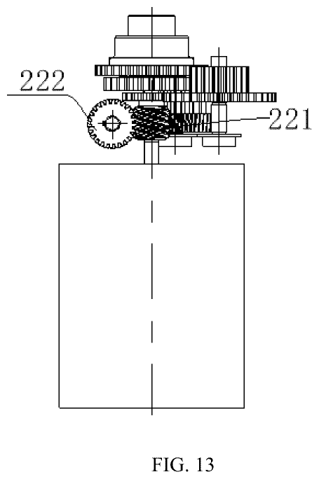

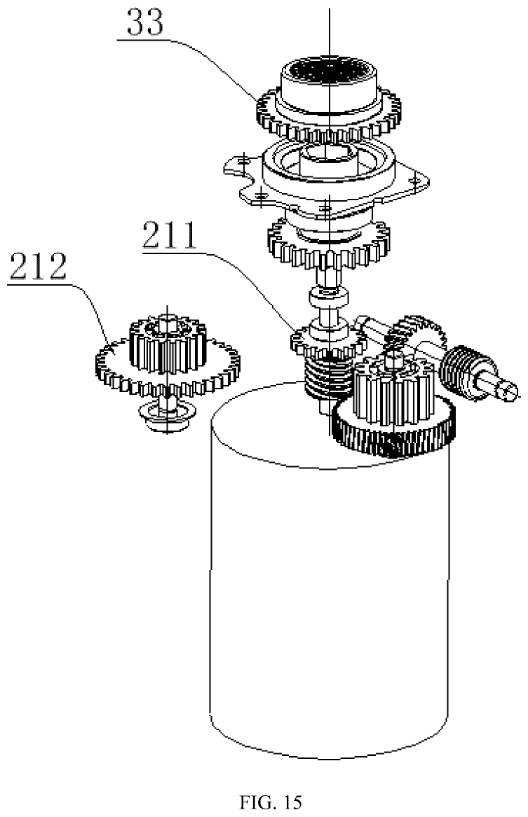

In a specific embodiment of the present application, as shown in FIG. 9 to FIG. 15, the drive member 11 is used as a power input and provides three different speed outputs through the speed change mechanism 2. The three outputs are the first-stage output end 31, the second-stage output end 32 and the third-stage output end 33, respectively.

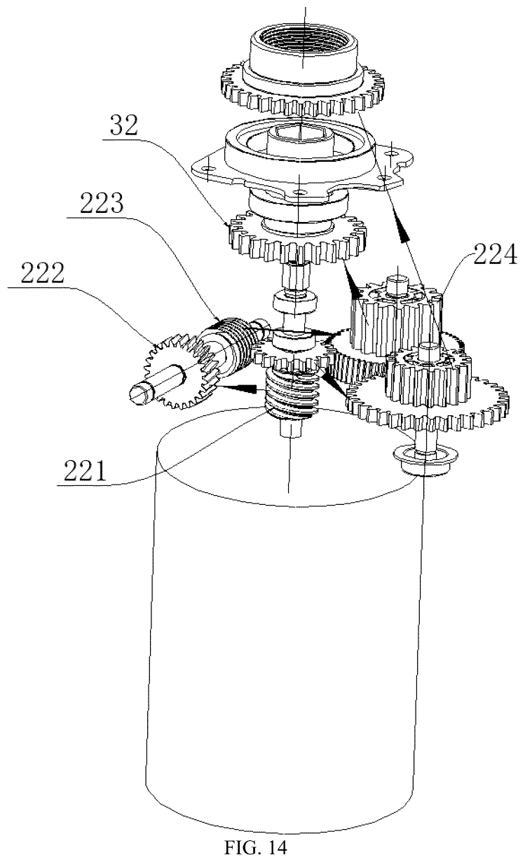

It is understandable that, as shown in FIG. 14, a direction of the arrow in the figure indicates a direction of power transmission, the drive member 11 drives the drive shaft 12 to rotate, and the first-stage output end 31 connected to the drive shaft 12 outputs a first speed, which may be used as a wall-breaking machine. At the same time, the drive shaft 12 is decelerated by a first-stage worm gear (meshed first worm gear 221 and the first worm wheel 222) and then transmitted to a second-stage worm gear (meshed second worm gear 223 and the second worm wheel 224), and is transmitted to the second toothed connection part 321 through the second worm wheel 224. The second-stage output end 32 outputs a second speed, which may be used as a slow juicer. The drive shaft 12 transmits power to the driven gear 212 through the driving gear 211, and then transmits to the first toothed connection part 331. The third-stage output end 33 outputs a third speed, which may be used as a food processor. It may be seen that in the drive device of the present application, the first-stage wall-breaking function is realized through the drive shaft 12, the second-stage food cooking function is realized through the drive shaft 12 and variable speed of the gear set, and the third-stage slow juicer function is realized through the drive shaft 12, the worm gear and variable speed of the gear set.

It should be noted that the traditional food processor usually includes two output structures, and the reduction ratio and output torque are small, which may only realize two cooking functions, and cannot realize one machine for multiple uses. It needs to be equipped with other machines, and the user experience is poor. However, in the embodiment of the present application, one speed input and three different speed outputs may be realized through the speed change mechanism 2, which may realize three cooking functions, and the speed and torque range is wide.

According to the drive device of the embodiment of the present application, the output mechanism 3 is provided with coaxial multi-stage output ends, the maximum reduction ratio is more than 300, the maximum output torque is more than 30 Nm, and the speed may be from 40 rpm to 24000 rpm. It may be seen that the drive device of the present application has a wide output speed and torque range, and may be matched with a variety of functional devices with different functions to meet the needs of users for more recipes and food, and one machine can be used for multiple uses, which has the characteristics of convenience and thrift.

An embodiment of the present application provides a food processor, including a housing, a functional device and a drive device according to any of the above embodiments. The housing is wrapped around the outside of the drive device; the functional device includes a cup body and a working component rotatably arranged inside the cup body, where the cup body is detachably connected to the housing, and the working component is connected to the first-stage output end or any of the power output end.

It is understandable that the food processor may be commercially available products such as a food processor, a soymilk machine, a blender, a juicer, and the like.

It is understandable that under the drive of the drive member 11, the drive shaft 12 drives the output mechanism 3 to move, and the working component connected to the output end of the output mechanism 3 may perform processing operations such as whipping and grinding on the food in the cup body. The number of functional devices and the number of output ends of the output mechanism 3 may be equal and correspond one to one. By assembling functional devices with different functions on the corresponding output ends, different food processing functions may be realized.

It should be noted that the above embodiments are only used to explain the solutions of the present application, and are not limited thereto; although the present application has been described in detail with reference to the foregoing embodiments, it should be understood by those skilled in the art that modifications to the solutions documented in the foregoing embodiments, or equivalent substitutions to a part of the features therein may be made; and these modifications and substitutions do not make the essence of the corresponding solutions depart from the scope of the solutions of various embodiments of the present application.

1-11. (canceled)

12. A drive device comprising:
a drive shaft;
a speed change mechanism; and
an output mechanism, including:
a first-stage output end connected to the drive shaft; and
at least one power output end connected to the drive shaft through the speed change mechanism;
wherein:
the first-stage output end and the at least one power output end are concentrically arranged and sequentially sleeved; and
speeds output from the first-stage output end and the at least one power output end are different.

13. The drive device of claim 12, wherein:
the at least one power output end includes a second-stage output end;
the first-stage output end and the second-stage output end are sequentially sleeved from inside to outside; and
a speed of the first-stage output end is greater than a speed of the second-stage output end.

14. The drive device of claim 13, wherein:
the at least one power output end further includes a third-stage output end sleeved at the second-stage output end; and
a speed of the third-stage output end is smaller than the speed of the first-stage output end and greater than the speed of the second-stage output end.

15. The drive device of claim 12, wherein the speed change mechanism includes a first transmission assembly and a second transmission assembly, a transmission ratio of the first transmission assembly being smaller than a transmission ratio of the second transmission assembly.

16. The drive device of claim 15, wherein:
the first transmission assembly is power-coupled to the third-stage output end and connected to the drive shaft; and
the second transmission assembly is power-coupled to the second-stage output end and connected to the drive shaft.

17. The drive device of claim 15, wherein:
the third-stage output end is provided with a toothed connection part; and
the first transmission assembly includes:
a driving gear sleeved at the drive shaft; and
a driven gear including:
first outer annular teeth meshed with the driving gear; and
second outer annular teeth meshed with the toothed connection part.

18. The drive device of claim 15, wherein:
the third-stage output end includes a toothed connection part; and
the first transmission assembly includes:
a driving gear sleeved at the drive shaft;
a first driven gear meshed with the driving gear; and
a second driven gear connected to the first driven gear through a rotary shaft and meshed with the toothed connection part.

19. The drive device of claim 15, wherein:
the second-stage output end includes a toothed connection part at an exterior of the second-stage output end; and
the second transmission assembly includes:
a first worm sleeved at the drive shaft;
a first worm wheel meshed with the first worm;
a second worm connected to the first worm wheel; and
a second worm wheel meshed with the second worm and meshed with the toothed connection part.

20. The drive device of claim 19, wherein:
the second worm wheel includes first outer annular teeth and second outer annular teeth arranged coaxially; and
the first outer annular teeth are meshed with the second worm, and the second outer annular teeth are meshed with the toothed connection part.

21. The drive device of claim 15, wherein:
the second-stage output end includes a toothed connection part at an exterior of the second-stage output end; and
the second transmission assembly includes:
a first worm connected to the driven gear;
a first worm wheel meshed with the first worm;
a second worm connected to the first worm wheel; and
a second worm wheel meshed with the second worm and meshed with the toothed connection part.

22. The drive device of claim 21, wherein:
the second worm wheel includes first outer annular teeth and second outer annular teeth arranged coaxially; and
the first outer annular teeth are meshed with the second worm, and the second outer annular teeth are meshed with the toothed connection part.

23. The drive device of claim 15, wherein:
the first transmission assembly includes:
a driving gear sleeved at the drive shaft;
a first driven gear meshed with the driving gear; and
a second driven gear connected to the first driven gear through a rotary shaft;
the second-stage output end includes a toothed connection part at an exterior of the second-stage output end; and
the second transmission assembly includes:
a first worm sleeved at the rotary shaft;
a first worm wheel meshed with the first worm;
a second worm connected to the first worm wheel; and
a second worm wheel meshed with the second worm and meshed with the toothed connection part.

24. The drive device of claim 23, wherein:
the second worm wheel includes first outer annular teeth and second outer annular teeth arranged coaxially; and
the first outer annular teeth are meshed with the second worm, and the second outer annular teeth are meshed with the toothed connection part.

25. A food processor comprising:
a drive device including:
a drive shaft;
a speed change mechanism; and
an output mechanism, including:
a first-stage output end connected to the drive shaft; and
at least one power output end connected to the drive shaft through the speed change mechanism;
wherein:
the first-stage output end and the at least one power output end are concentrically arranged and sequentially sleeved; and
speeds output from the first-stage output end and the at least one power output end are different;
a housing, containing the drive device; and
a functional device including:
a cup body detachably connected to the housing; and
a working component rotatably arranged inside the cup body and connected to the first-stage output end or any of the at least one power output end.

26. The food processor of claim 25, wherein:
the at least one power output end includes a second-stage output end;
the first-stage output end and the second-stage output end are sequentially sleeved from inside to outside; and
a speed of the first-stage output end is greater than a speed of the second-stage output end.

27. The food processor of claim 26, wherein:
the at least one power output end further includes a third-stage output end sleeved at the second-stage output end; and
a speed of the third-stage output end is smaller than the speed of the first-stage output end and greater than the speed of the second-stage output end.

28. The food processor of claim 25, wherein the speed change mechanism includes a first transmission assembly and a second transmission assembly, a transmission ratio of the first transmission assembly being smaller than a transmission ratio of the second transmission assembly.

29. The food processor of claim 28, wherein:
the first transmission assembly is power-coupled to the third-stage output end and connected to the drive shaft; and
the second transmission assembly is power-coupled to the second-stage output end and connected to the drive shaft.

30. The food processor of claim 28, wherein:
the third-stage output end is provided with a toothed connection part; and
the first transmission assembly includes:
a driving gear sleeved at the drive shaft; and
a driven gear including:
first outer annular teeth meshed with the driving gear; and
second outer annular teeth meshed with the toothed connection part.

31. The food processor of claim 28, wherein:
the third-stage output end includes a toothed connection part; and
the first transmission assembly includes:
a driving gear sleeved at the drive shaft;
a first driven gear meshed with the driving gear; and
a second driven gear connected to the first driven gear through a rotary shaft and meshed with the toothed connection part.
